(19) United States
(12) Patent Application Publication
(10) Pub. No.: US 2011/0036989 A1
(43) Pub. Date: Feb. 17, 2011

(54) COUNTING DETECTOR

(75) Inventors: Aviv Marks, Raanana (IL); Christoph Herrmann, Aachen (DE); Ewald Roessl, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/988,522

(22) PCT Filed: Mar. 20, 2009
(86) PCT No.: PCT/IB09/51192

§ 371 Date: Oct. 19, 2010

Related U.S. Application Data
(60) Provisional application No. 61/049,068, filed on Apr. 30, 2008.

(51) Int. Cl. G01T 1/17

(52) U.S. Cl. 250/370.08

(57) ABSTRACT

A pulse shaper (124) includes an integrator (202) with a feedback capacitor (208) that stores integrated charge of a charge pulse indicative of a detected photon. An output pulse of the integrator includes a peak amplitude indicative of the detected photon. An end pulse identifier (214) identifies the end of the charge pulse. A controller (216) generates a control signal that invokes a reset of the integrator (202) when the end of the 5 pulse is identified. An energy discriminator (128) includes a chain of comparators (132) connected in series. An output of each of the comparators (702, 704) is influenced by an output of a previous one of the comparators 712 (702, 704). A decision component (706) determines an output of the comparators (702, 704), and a controller component (708) triggers the decision component (706) to store the output of the comparators (702, 704) 10 after lapse of a charge collection time.

The following generally relates to a particle counting detector. While it is described with particular application to photon counting in connection with computed tomography (CT), it also relates to other applications in which it is desirable to count particles.

A computed tomography (CT) system includes a radiation source that emits poly-energetic ionizing photons that traverse an examination region. Systems configured for counting photons may also include a multi-spectral detector such as a CZT detector with an array of radiation sensitive pixels, located opposite the examination region from the radiation source, which detect photons that traverse the examination region. Each pixel of the detector array produces an electrical signal for each photon that it detects, wherein the electrical signal is indicative of the energy of that photon. The system also includes electronics for energy-resolving the detected photons based on the electrical signal.

The electronics have included a pulse shaper, which processes incoming charge from a pixel and produces a voltage pulse with the peak amplitude indicative of the energy of the detected photon. The electronics have also included a discriminator that compares the amplitude of the voltage pulse with one or more thresholds that are set in accordance with different energy levels. Conventionally, the discriminator has included a different comparator for each threshold. FIG. 11 shows an example with N thresholds/comparators. If the input voltage of a comparator exceeds the corresponding reference voltage, the output voltage of the comparator changes, which triggers a corresponding counter to increment. Additional logic is needed to assign the correct number of counts to the right energy window.

Unfortunately, a conventional pulse shaper may produce voltage pulses with relatively long decay times, resulting in a large elongation of the pulses, reducing the maximum count rate to mitigate pulse pile-up, which may lead to erroneous binning of the pulse. Furthermore, there is a limited area for the electronics. Consequently, with conventional approaches that employ a different comparator for each threshold, the limited area limits the number of comparators that can be used and, hence, limits the number of energy windows to the number of comparators. Moreover, each comparator consumes power and dissipates heat.

Aspects of the present application address the above-referenced matters and others.

According to one aspect, a pulse shaper of a photon counting detector of a medical imaging system includes an integrator with a feedback capacitor. The integrator integrates a charge pulse indicative of a detected photon, storing the integrated charge in the feedback capacitor, thereby producing an output voltage pulse with a peak amplitude indicative of the energy of the detected photon. An end pulse identifier identifies the end of the charge pulse and generates an output signal indicative thereof. A controller generates a control signal in response to the output signal, wherein the control signal invokes a reset of the integrator.

In another aspect, an energy discriminator of a photon counting detector of a medical imaging system includes a chain of comparators connected in series, wherein an output of each of the comparators is influenced by an output of a previous one of the comparators. A decision component determines an output of the comparators, which is indicative of the energy of a detected photon. A controller component triggers the decision component to store the output of the comparators after lapse of a charge collection time.

In another aspect, a photon counting detector of a medical imaging system includes a detector pixel that detects transmission radiation traversing an examination region, wherein the detector pixel produces a signal indicative of the energy of a photon detected by the detector pixel. A pulse shaper includes an integrator that receives the signal and produces a signal indicative of the energy of the detected photon, wherein the pulse shaper includes circuitry that selectively resets the integrator. An energy discriminator includes a chain of comparators connected in series that energy-discriminate the signal based on at least one voltage threshold that corresponds to a desired photon energy and generates a output signal indicative of the energy of the detected photon.

Still further aspects of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

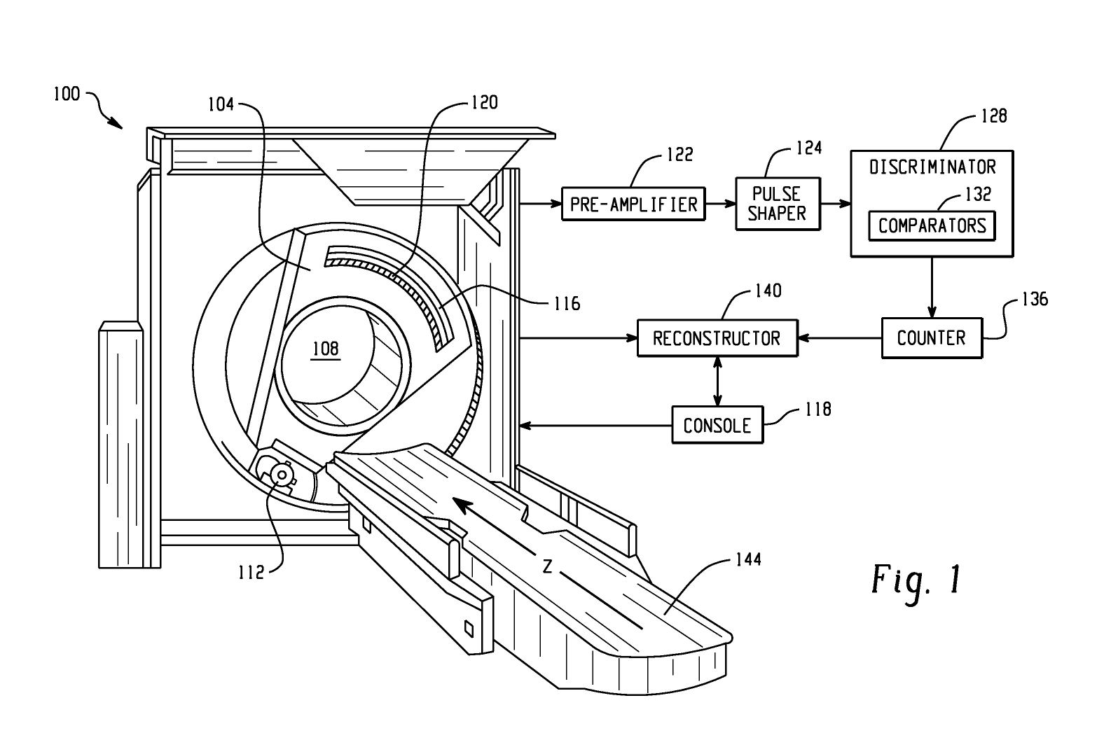

FIG. 1 illustrates an imaging system.

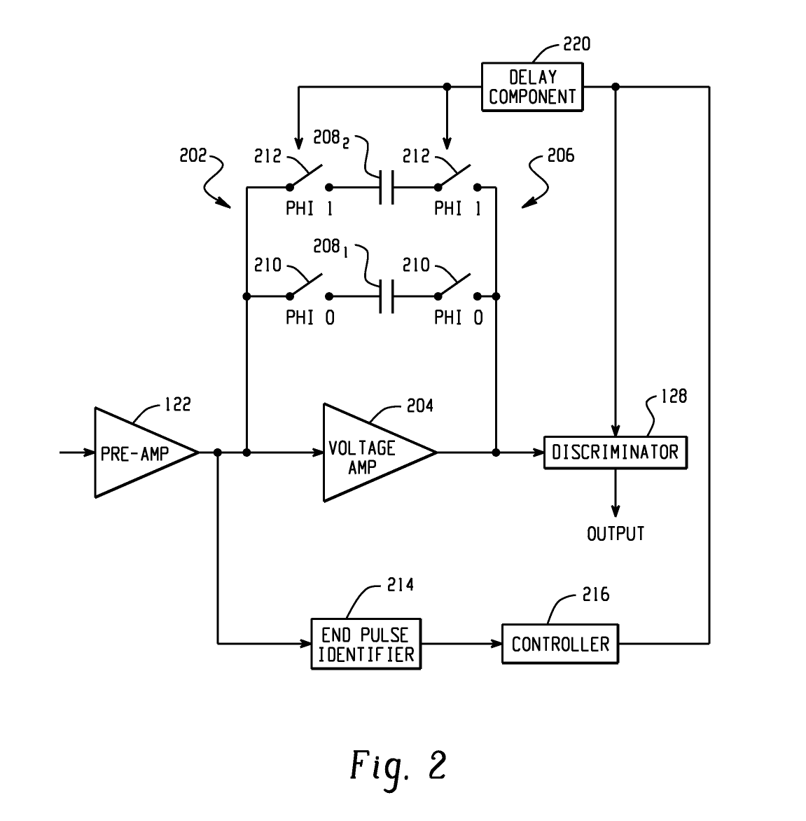

FIGS. 2 and 4-6 illustrate example pulse shapers.

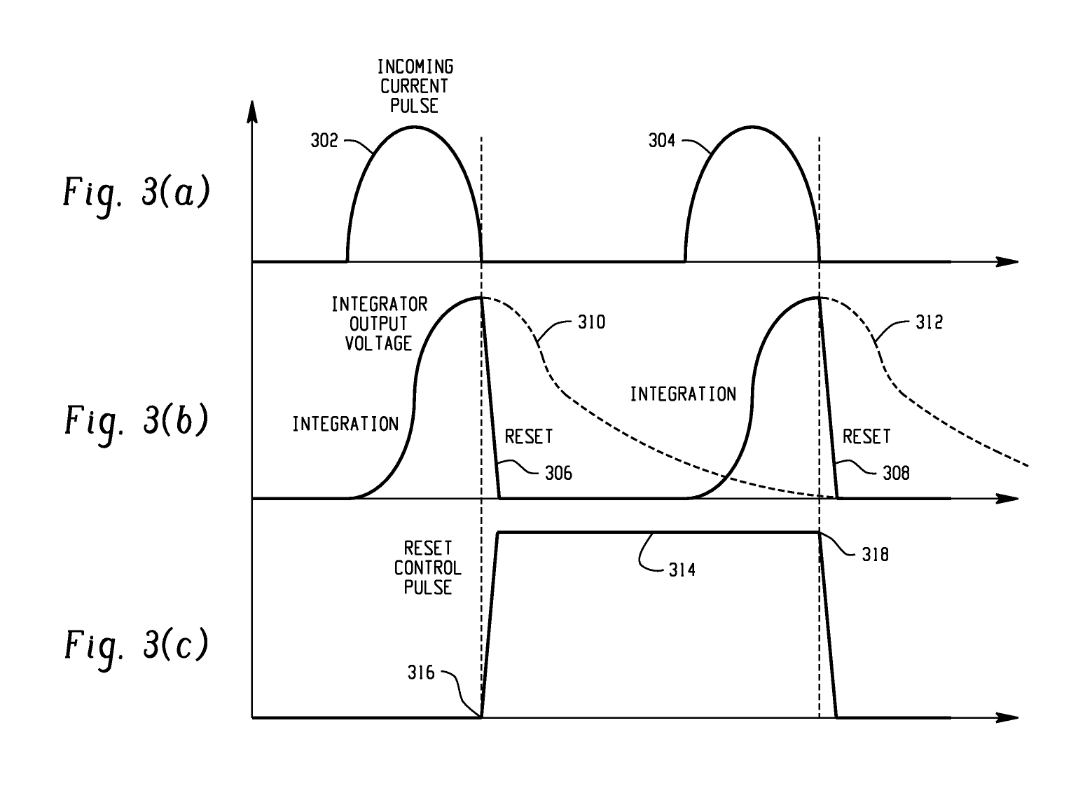

FIG. 3 illustrates and example charge, voltage, and reset pulses.

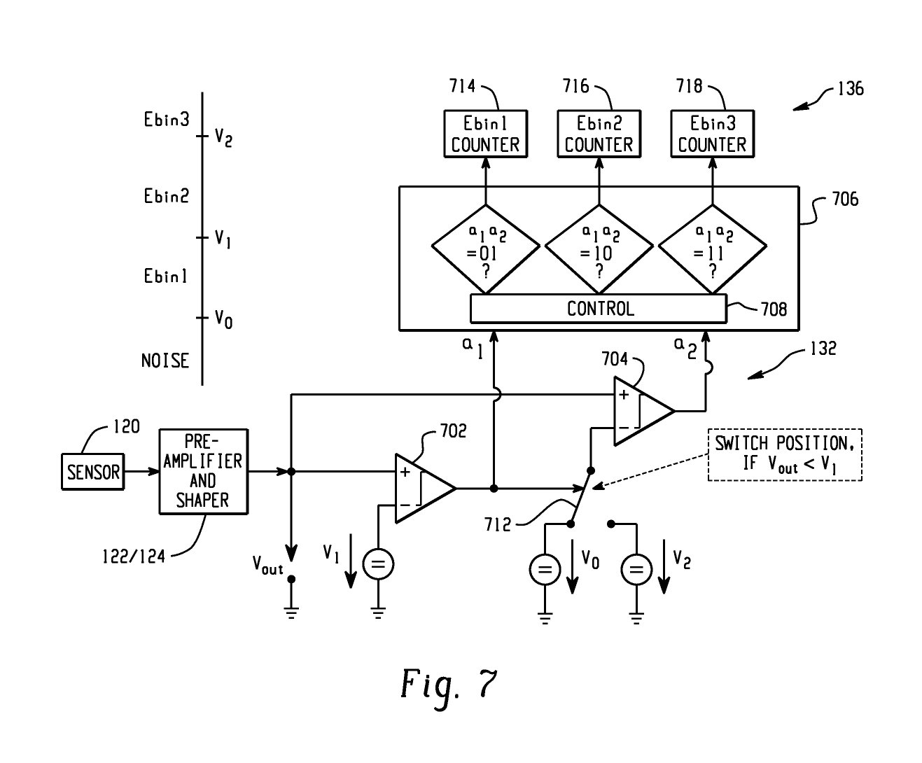

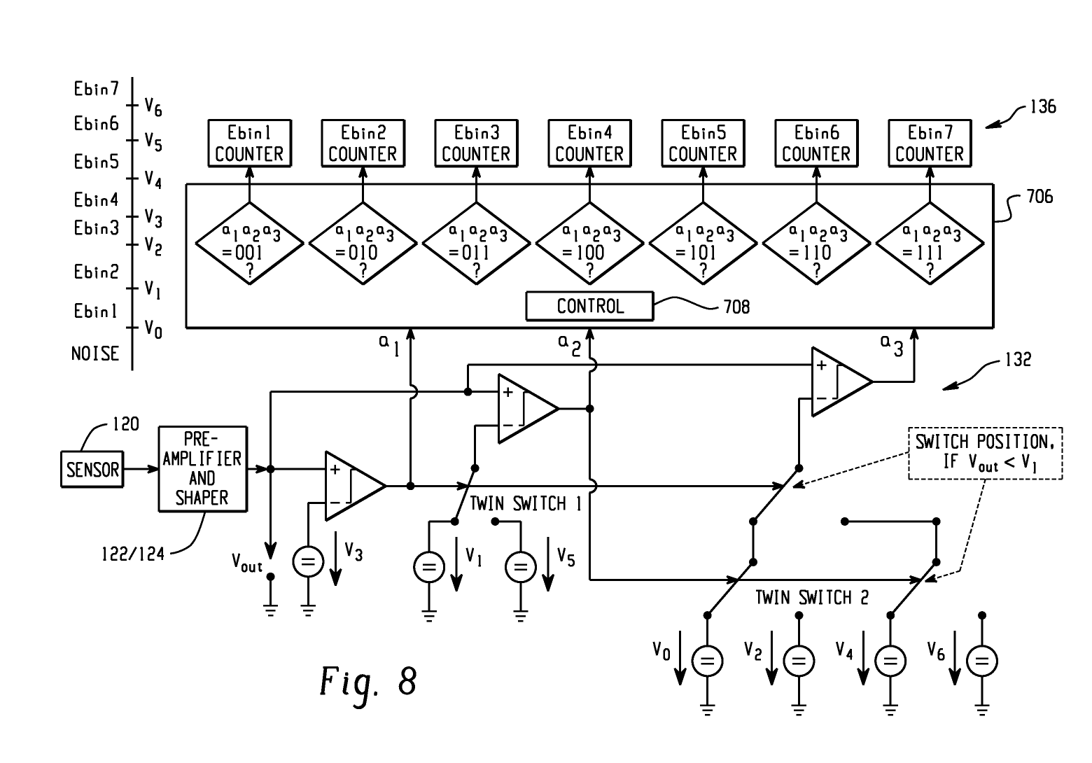

FIGS. 7 and 8 illustrate an example energy discriminator.

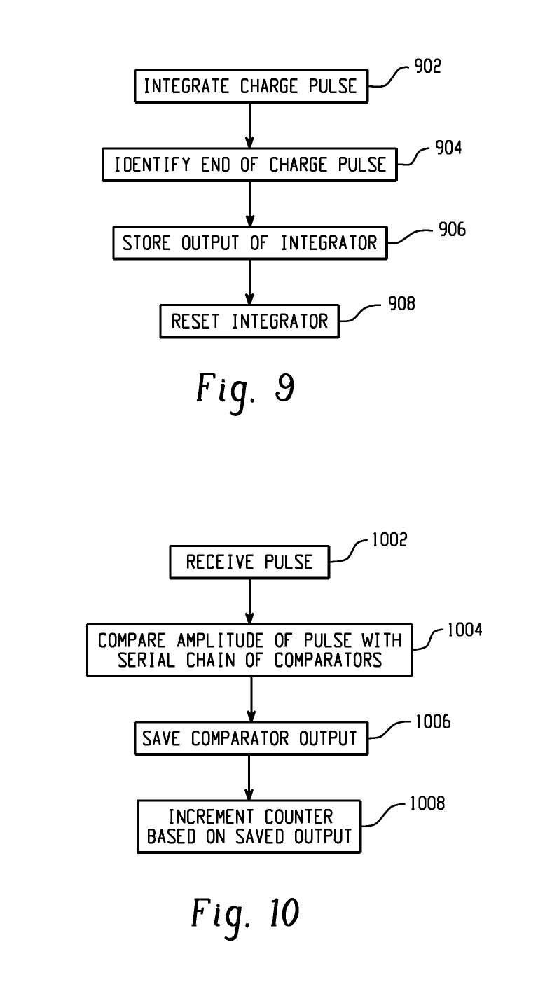

FIG. 9 illustrates a method of shaping a pulse from a detector pixel.

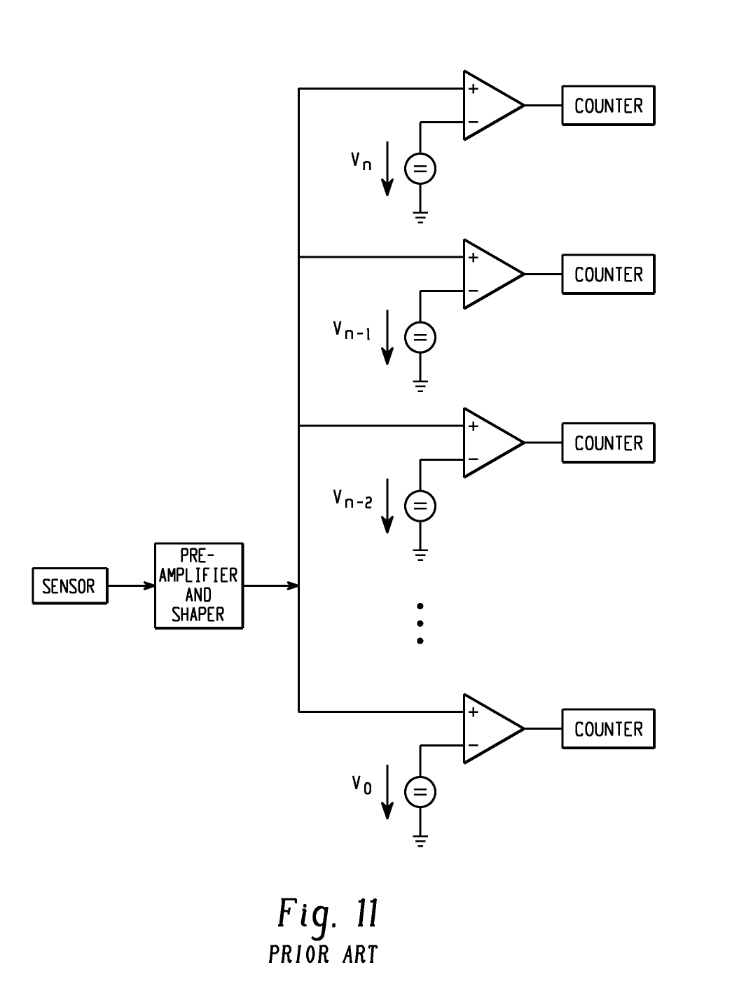

FIG. 10 illustrates a method of energy-discriminating a shaped pulse.

FIG. 11 illustrates a prior art discriminator.

With reference to FIG. 1, a computed tomography (CT) system 100 includes a rotating gantry 104 which rotates about an examination region 108 around a longitudinal or z-axis. An x-ray source 112, such as an x-ray tube, is supported by the rotating gantry 104 and emits a poly-energetic radiation beam that traverses the examination region 108. A radiation sensitive detector 116 includes at least one pixel or sensor 120 that detects photons emitted by the source 112. The pixel 120 generates a corresponding electrical signal, such as electrical currents or voltages, for each detected photon. Examples of suitable detectors 116 include a direct conversion detectors (e.g., cadmium zinc telluride (CZT)) and scintillator-based sensors that include a scintillator in optical communication with a photosensor. A pre-amplifier 122 amplifies the electrical signal.

A pulse shaper 124 processes the electrical signal and generates a pulse such as voltage or other pulse indicative of the energy of the detected photon. As described in greater detail below, the pulse shaper 124 can include reset circuitry that resets the shaper 124 after the end of the incoming charge pulse has been identified. By way of non-limiting example, the circuitry may swap out a feedback capacitor storing the integrated charge, cancel the stored charge by applying a charge of equal magnitude but opposite sign, or release the stored charge, all upon identifying the end of the incoming charge pulse. In one instance, this results in a fast reset of the shaper 124 after the end of the incoming charge pulse, which results in a shorter pulse tail, allowing for a higher count rate, relative to a configuration in which the feedback capacitor is discharged by allowing the stored charge to decay via the decay time constant of the shaper 124. Of course, a pulse shaper without the fast reset may alternatively be used.

An energy discriminator 128, with at least one comparator 132, energy-discriminates the pulses from the shaper 124. This includes comparing the peak amplitude of the output pulse of the shaper 124 with one or more thresholds that respectively correspond to particular energy levels, and producing an output signal indicative of an energy range in which the energy of the photon falls within. As discussed in greater detail below, the discriminator 128 can include a chain of serially connected comparators 132 in which each comparator is influenced by the output of a previous comparator. In one instance, this allows for a reduction in the number of comparators (from 2^{N}−1 to N) used for a given number of energy windows (2^{N}−1) without compromising spectral sensitivity. This may also result in a reduction of chip area, power consumption and/or heat dissipation for a given number of energy windows. Alternatively, the number of energy windows can be increased for a given number of comparators, chip area, power consumption, and/or heat dissipation. Of course, an energy discriminator without a chain of serially connected comparators 132 may alternatively be used.

A counter 136 increments a count value for each threshold or for each energy window based on the output of the energy discriminator 128. The count value provides information used to energy-resolve the detected photons. A reconstructor 140 selectively reconstructs the signals generated by the detector 116 based on the spectral characteristics determined by energy-resolving the signals output by the detector pixels (120). An object support 144 such as a couch supports a patient or other object in the examination region 108. The object support 144 is movable so as to guide the object with respect to the examination region 108 when performing a scanning procedure. A general purpose computer serves as an operator console 118. The console 118 includes a human readable output device such as a monitor or display and an input device such as a keyboard and mouse. Software resident on the console 118 allows the operator to control and interact with the scanner 100, for example, through a graphical user interface (GUI).

As discussed above, the pulse shaper 124 processes incoming charge from a detector pixel (120) and produces a voltage pulse having peak amplitude indicative of the energy of the detected photon. FIGS. 2 and 4-6 illustrate examples of suitable pulse shapers, and FIG. 3 shows example charge pulses, voltage pulses, and a reset pulse.

Initially referring to FIG. 2, the pulse shaper 124 includes an integrator 202, comprising an amplifier 204 and a feedback capacitor bank 206. The amplifier 204 can be an operational amplifier or other amplifier. The feedback capacitor bank 206 includes a first capacitor 208₁ and a second capacitor 208₂ (collectively referred to herein as capacitors 208). The capacitors 208 are selectively electrically coupled with the amplifier 204 for electrical communication therewith in the feedback loop.

In this example, the capacitors 208 are coupled with the amplifier 204 via respective switches 210 and 212, which alternately couple the capacitors 208 with the amplifier 204. As such, when the switches 210 are closed, the switches 212 are open and the capacitor 208₁ is in electrical communication with the amplifier 204, and when the switches 212 are closed, the switches 210 are open and the capacitor 208₂ is in electrical communication with the amplifier 204. A resistor can be added in series with the capacitors 208, which may reduce slewing, thereby allowing a more relaxed settling time.

An end pulse identifier 214 identifies an end of the incoming charge pulse from the pre-amplifier 122. Various techniques can be used to do this. By way of non-limiting example, the end pulse identifier 214 may identify the end of the pulse by determining a zero derivative of the incoming pulse, the end of a time interval from the beginning of the charge pulse, etc. An output signal of the end pulse identifier 214 is indicative of whether the end of the pulse has been occurred.

A controller 216 produces a control signal based on the output of the end pulse identifier 214. It is to be appreciated that the controller 216 can include a T-flip flop or other component that provides an output signal which toggles between states based on the output of the end pulse identifier 214. The control signal is fed to the discriminator 128, which notifies the discriminator 128 that the peak of the pulse has occurred. In response, the output of the discriminator 128 is read and/or stored, for example, via sample and hold or other circuitry.

The control signal is also used to toggle the state of the switches 210 and 212, which swaps the capacitor 208, thereby effectively resetting the integrator 202 by removing the charged capacitor 208 and replacing it with a discharged capacitor 208. A delay component 220 in the path from the controller 216 to the capacitor bank 206 delays the control signal to the capacitor bank 206. In one instance, the delay is set so that the output value of the amplifier 204 can be read prior to swapping the capacitors 208.

In operation, a discharged or base-line charged one of capacitors 208 is electrically coupled to the feedback loop of the integrator 202. As charge enters the integrator 202, the feedback capacitor 208 in the loop accumulates and stores the charge associated therewith, thereby producing a voltage indicative of the charge at the output of the integrator 202. The end pulse identifier 214 identifies the end of the incoming charge pulse as noted above and generates a signal indicative thereof. The controller 216, based on this signal, generates a control signal that invokes the discriminator 128 to read the output value of the integrator 202.

After a pre-defined delay via the delay component 220, the control signal is also provided to the capacitor bank 206, toggling the states of the switches 210 and 212, which swaps the capacitors 208 in the feedback loop. As such, the charged capacitor is replaced with a discharged or base-line charged one of the capacitors 208. In one instance, this is essentially equivalent to substantially instantaneously discharging the capacitor to a pre-defined initial state. As such, the integrator 202 quickly resets for the next incoming pulse within a shorter time duration relative to discharging the capacitor 208 without swapping the capacitors 208. In one instance, resetting the capacitor 208 in the feedback loop as such may be fast enough to mitigate dead time before the next incoming charge pulse is received by the integrator 202.

Briefly turning to FIG. 3, FIG. 3a illustrates example charge pulses 302 and 304 in a stream of charge pulses received by the integrator 202. FIG. 3b illustrates the output voltage pulse of the integrator 202 for each of the charge pulses 302 and 304 respectively when resetting the integrator 202 via swapping the capacitors 208 (306 and 308) and discharging the capacitors 208 without swapping the capacitors 208 by allowing the stored charge to decay via the time constant (310 and 312). In this example, the voltage pulse 310 is an elongated pulse with a long decaying tail that overlaps the voltage pulse 312. The contribution from the tail may erroneously increase the peak amplitude of the pulse 312. By suitably timing the end of the charge pulse and resetting the integrator 202 through swapping capacitors, a relatively faster count channel is achieved. FIG. 3c illustrates an example control signal 314 from the controller 216. As shown at 316 and 318, the state of the control signal 314 changes at the end of the charge pulse, which invokes swapping of the capacitors 208 and, hence, resetting of the integrator 202.

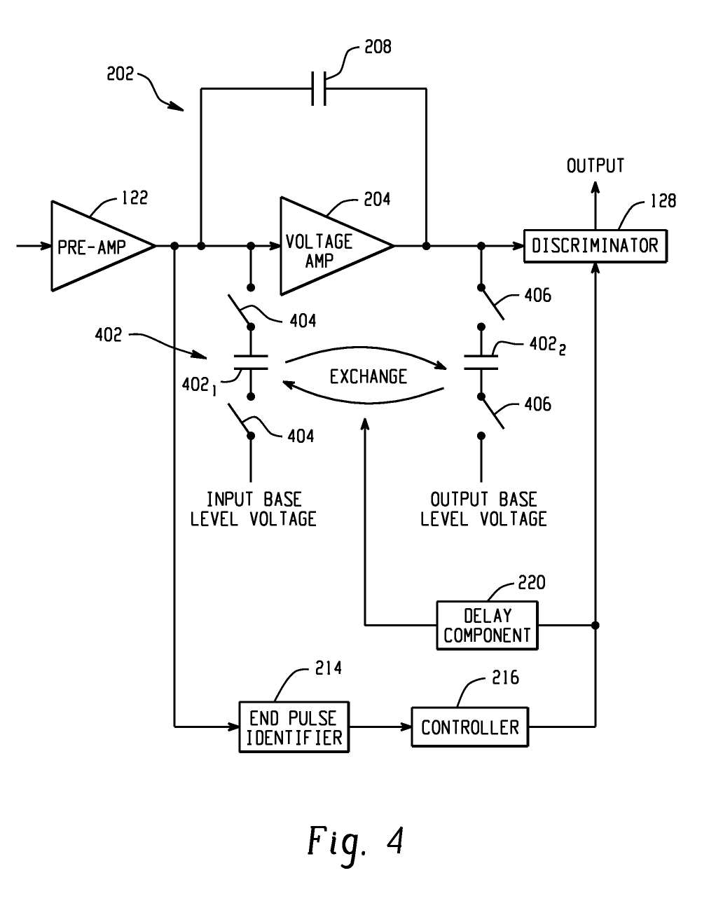

Now turning to FIG. 4, the pulse shaper 124 includes a single one of the feedback capacitors 208 in the capacitor bank 206. The pulse shaper 124 also includes first and second reset capacitors 402₁ and 402₂ (collectively referred to as capacitors 402), which are respectively alternately electrically coupled between an input of the integrator 202 and an input base level voltage and between an output of the integrator 202 and an output base level voltage via switches 404 and 406. As such, when the capacitor 402₁ is coupled to the input via the switches 404, the capacitor 402₂ is coupled to the output via the switches 406 (as shown), and vice versa. In this example, the capacity of the capacitors 208, 402₁ and 402₂ is substantially equal. The control signal determines which of the reset capacitors 402 is coupled to the input and which is coupled to the output.

In operation, the capacitors 402 are coupled to the integrator 202, one to the input and the other one to the output. In the illustrated example, the capacitor 402₁ is coupled to the input and the capacitor 402₂ is coupled to the output. As charge enters the integrator 202, the feedback capacitor 208 accumulates and stores the charge associated therewith, thereby producing a voltage indicative of the charge at the output of the integrator 202. The end pulse identifier 214 identifies the end of the incoming charge pulse and generates a signal indicative thereof. The controller 216, based on this signal, generates a control signal that invokes the discriminator 128 to read the output value of the integrator 202.

After a pre-defined delay via the delay component 220, the control signal invokes toggling of the switches 404 and 406, which exchanges the capacitors 402 such that the capacitor 402₁ is coupled to the output and the second capacitor 408₂ is coupled to the input. As a consequence, a charge pulse, which is substantially equal to the stored charge in the feedback capacitor 208 but opposite in sign, is provided to the input of the integrator 202, discharging the capacitors 208, hence, resetting the integrator 202. As such, the integrator 202 is more quickly reset relative to resetting the capacitor 208 by letting the stored charge decay. Again, a resistor can be added in serial with the capacitors 208 to reduce slewing. Since the discharge is achieved through current flowing into the integrator 202, the integrator 202 can be reset while integrating the next incoming charge pulse.

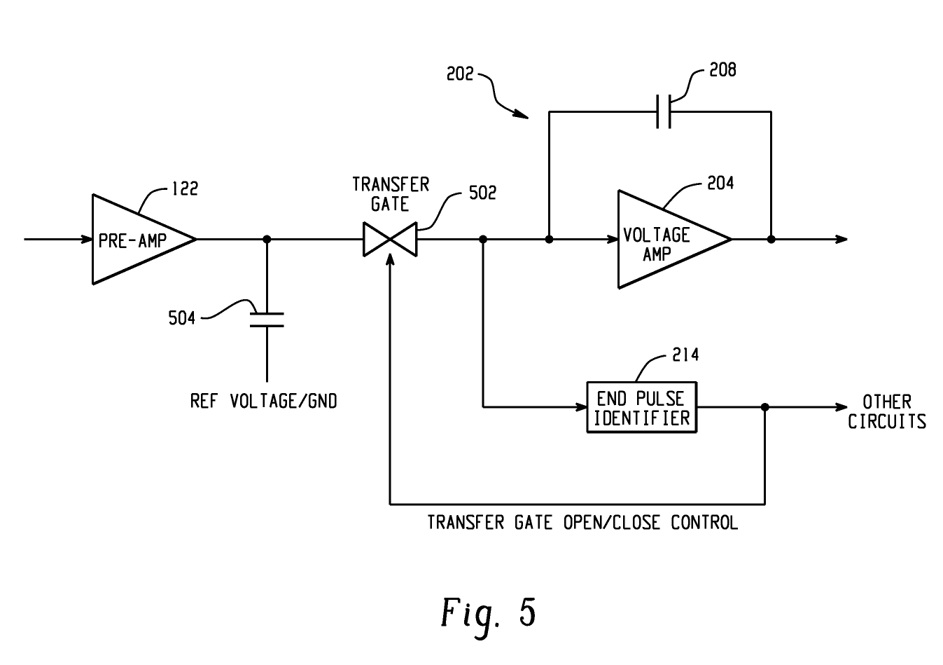

FIG. 5 shows a variant that can be used with one or both of the examples discussed in connection with FIGS. 2 and 4. For sake of brevity and clarity, the capacitor bank 206 of FIG. 4 is shown. A transfer gate 502 is located in the path of the charge pulse. The output signal of the end pulse identifier 214 toggles the state of the transfer gate 502. In this example, when the end pulse identifier 214 identifies the end of the incoming charge pulse, the state of the output signal invokes the transfer gate 502 to open, and the integrator 202 resets as discussed above. When the transfer gate 502 is open, charge is not provided to the integrators 202. Upon a reset, the state of the control signal changes and invokes the transfer gate 502 to close, allowing charge of the next incoming charge pulse to flow to the integrator 202.

In the illustrated example, a capacitor 504 is placed between the charge pulse and the transfer gate 502. The capacitor 504 accumulates incoming charge when the transfer gate 502 is opened, releasing the charge to the integrator 202 when the transfer gate 502 closes. With the shaper in FIG. 2, the transfer gate 502 is opened slightly before the capacitor swap. As a result, no current flow into the capacitor 208 from any external source, forcing a complete reset of the output since zero charge means zero output voltage. When a complete reset has been reached, as determined by a reset sensing circuit or a timed delay, the transfer gate 502 can be opened and the stored charged is released into the integrator 202. With the shaper of FIG. 4, the transfer gate 502 again is opened before the reset is done, and hence charge cannot escape the feedback capacitor 208, and the transfer gate 502 can be triggered to close in response to a reset sensing circuit or by a timed delay.

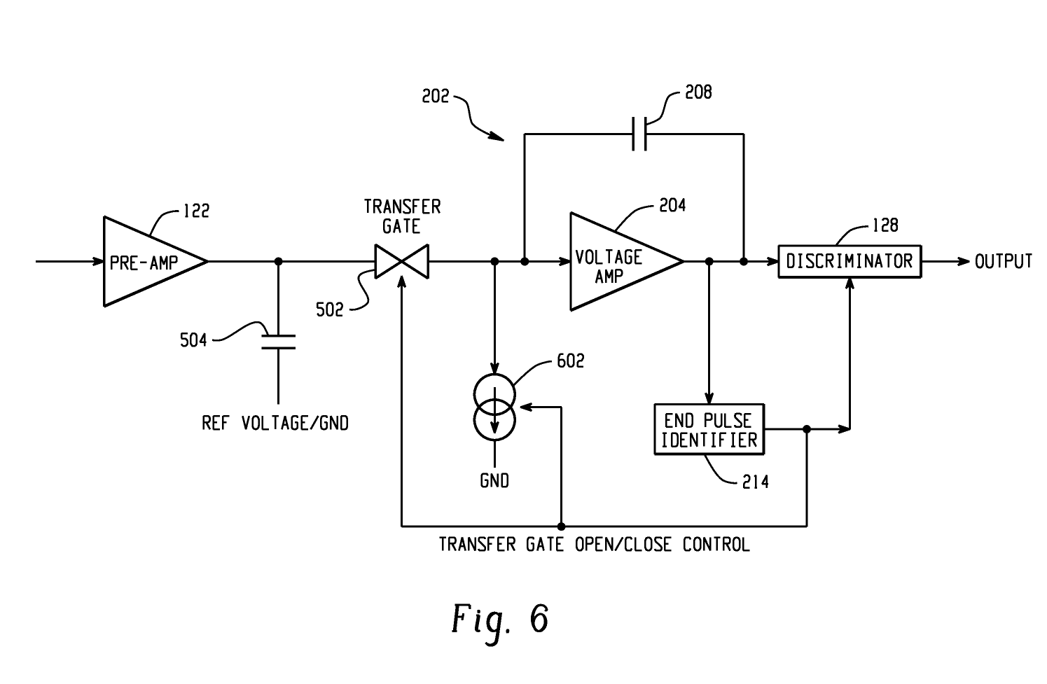

Turning to FIG. 6, the shaper 124 also includes a charge pump 602, which is in the path of the charge pulse before the integrator 202. In this example, the end pulse identifier 214 identifies both the end of the charge pulse and a reset of the integrator 202 by the output of the integrator 202. The output of the end pulse identifier 214 activates and deactivates both the charge pump 602 and the transfer gate 502.

The charge pump 602 is activated and the transfer gate 502 is open when the end pulse identifier 214 identifies the end of the charge pulse. When the transfer gate 502 is opened and the charge pump 602 is activated, the charge pump 602 releases the charge from the feedback capacitor 208 of the integrator 202. The charge pump 602 is deactivated and the transfer gate 502 is closed when the end pulse identifier 214 identifies that the feedback capacitor is discharged. When the transfer gate 502 is closed and the charge pump 602 is deactivated, the integrator 202 can again integrate incoming charge. It is to be appreciated that the current used by the charge pump 602 can be varied in proportion to the amplitude of the signal, hence assuring an accurate level reset.

In another embodiment, the charge pump 602 is a controlled charge pump. In this instance, when a large voltage gap exists at the output, a large current can be used to generate a rapid discharge. When the gap is closed, the current is decreased allowing a reset to substantially zero charge. This can be achieved by feeding a difference current of the amplifier to the charge pump 602, where its output voltage will determine a complete reset.

As discussed above, the discriminator 128 discriminates the pulses from the shaper 124. FIGS. 7 and 8 illustrate examples of suitable discriminators 128. In general, in the following examples the discriminator 128 includes a plurality of comparators 132 connected to each other in series. In one instance, this allows for the serialization of threshold decisions. As a result, the number of comparators 132 for 2^{N}−1 energy windows is N, which is a reduction in the number of comparators 132 relative to a configuration in which a comparator 132 is used for each threshold, resulting in 2^{N}−1 comparators 132. As such, the foot print of the discriminator 128 can be reduced for a given number of energy windows. Reducing the number of comparators 132 also may reduce power consumption and/or heat dissipation. Alternatively, the number of energy windows per a given foot print can be increased.

Initially referring to FIG. 7, the discriminator 128 includes three energy windows, Ebin3, Ebin2 and Ebin1. As discussed above, there is a correlation between the energy of a detected photon and the peak amplitude of the voltage pulse from the shaper 124 for the detected photon. As such, a photon energy window of interest can be described in terms of a corresponding voltage range. In this example, the highest energy window, Ebin3, corresponds to voltages from V2 to the voltage ceiling; an intermediate energy window, Ebin2, corresponds to voltage from V1 to V2, and the lower energy window, Ebin1, corresponds to voltages from V0 to V1, wherein V0 represents a base line voltage level above a noise level.

The discriminator 128 includes first and second comparators 702 and 704, a decision component 706, a control component 708, and the counter 136. The voltage pulse from the shaper 124 is provided as an input to both of the comparators 702 and 704. The second reference voltage V1 is provided as the other input to the first comparator 702. The first and third reference voltages V0 and V2 are alternately provided as the other input to the second comparator 704 based on the output of the first comparator 702. In this example, a switch 712 alternately electrically couples the first and third reference voltages V0 and V2 with the second comparator 704.

The output of the first comparator 702 controls the switch 712. For instance, when the amplitude of the voltage pulse is below V1, the output of the first comparator 702 transitions the switch 712 to a first position, which couples one of the reference voltages V0 or V2 with the second comparator 704, and when the amplitude of the voltage pulse is above V1, the output of the first comparator 702 transitions the switch 712 to a second position, which couples the other one of the reference voltages V0 or V2 with the second comparator 704.

The output from both of the comparators 702 and 704 is provided to the decision component 706. The decision component 706, based on the both of the outputs, invokes incrementing a corresponding sub-counter 714, 716 or 718 of the counter 136. In this example, the counter 714 corresponds to Ebin1, the counter 716 corresponds to Ebin2, and the counter 718 corresponds to Ebin3. The control component 708 controls when the output values of the comparators 702 and 704 are stored and a sub-counter is incremented.

The control component 708 triggers the storing of the values from the comparators 132 after lapse of a charge collection time. The charge collection time is indicative of an estimated amount of time it takes for voltage pulse to build up, and begins when the amplitude of the incoming voltage pulse exceeds V0. Triggering the decision component 706 based on the charge time ensures that the peak amplitude of the incoming pulse is received prior to storing the output values and incrementing a counter, thereby mitigating an erroneous count since as the voltage pulse builds up, the output of the first and second comparators 702 and 704 may change and the switch 712 may transition between positions.

In operation, a voltage pulse is received from the shaper 124. The voltage pulse is provided to the first and second comparators 702 and 704. The first comparator 702, based on the peak amplitude of the voltage pulse and a reference voltage, outputs a first signal. The first signal invokes the switch 712 to transition to either a first or a second position, if the switch 712 is not already in such position. The switch 712 couples a suitable reference voltage to the second comparator 704. The second comparator 704, based on the peak amplitude of the voltage pulse and the reference voltage, outputs a second signal. The first and second signals, which together provide information indicative of the energy of the detected photon, are provided to the decision component 706. Based on the first and second signals and after the charge collection time, the counter 136 increments based on such that its value is indicative of an energy window within which the energy of the detected photon falls within. The above is repeated for each detected photon.

It is to be appreciated that discriminator 128 can be scaled down for two or less energy windows or up for more than three energy windows. As noted above, the serial comparator discriminator includes N comparators for 2^{N}−1 energy windows. Each of the N comparators 128 receives the incoming voltage pulse as well as a reference voltage or selectively one of a plurality of reference voltages. In one instance, the number of reference voltages for a comparator 128 generally is twice the number of reference voltages of the previous comparator 128, with the first comparator 128 in the serial chain having a single reference voltage. Similarly, the number of switches doubles for successive comparators 128, with the exception of the second comparator 128 in the chain since the first comparator 128 does not have switch. By way of example, the discriminator 128 in FIG. 8 includes three (N=3) comparators in series for seven (2^{N}−1, where N=3) energy windows.

FIG. 9 illustrates a method of shaping a pulse from a detector pixel. At 902, a charge pulse indicative of a detected photon is received and integrated by an integrator. At 904, the end of the charge pulse is identified. At 906, the output of the integrator is stored. At 908, the integrator is reset via a reset techniques described herein. The above acts are repeated for each detected photon.

FIG. 10 illustrates a method of energy-discriminating a shaped pulse. At 1002, a voltage pulse from a pulse shaper is received. At 1004, the peak amplitude of the voltage pulse is compared using a plurality of comparators connected in series. At 1006, the output of the chain is saved after a charge collection time lapses. At 1008, count corresponding to the energy of the detected photon is incremented. The above acts are repeated for each detected photon.

It is to be appreciated that the shaper 124 can be used for any analog processing channel in which the integral of the current over time (the charge) is the desired information. In particular, the shaper 124 can be used for those channels in which the rate of the incoming pulses is very high. The discriminator 128 can be used in applications based on counting single X-ray photons with small pixel sizes, in which high energy-resolution is of importance, e.g. for medical x-ray and/or x-ray CT applications based on spectral information at high photon-fluxes.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A pulse shaper of a photon counting detector of a medical imaging system, comprising:
an integrator with a feedback capacitor, wherein the integrator integrates a charge pulse indicative of a detected photon, storing the integrated charge in the feedback capacitor, thereby producing an output pulse with a peak amplitude indicative of the energy of the detected photon;
an end pulse identifier that identifies the end of the charge pulse and generates an output signal indicative thereof; and
a controller that generates a control signal in response to the output signal, wherein the control signal invokes a fast reset of the integrator.

2. The pulse shaper of claim 1, wherein the reset elicited by the control signal resets the integrator more quickly relative to allowing the charge stored in the feedback capacitor to decay based on a decay time constant of the integrator.

3. The pulse shaper of claim 1, further including:
a second feedback capacitor; and
first and second switches that respectively alternately electrically couple a different one of the feedback capacitors with the integrator based on the control signal, wherein the reset includes toggling the switches, thereby swapping a charged one of the feedback capacitors with a discharged one of the feedback capacitors.

4. The pulse shaper of claim 3, wherein the discharged one of the feedback capacitors is discharged to a baseline charge.

5. The pulse shaper of claim 1, further including:
first and second discharge capacitors; and
switches that selectively alternately electrically couple one of the discharge capacitors to an input of the integrator and the other one of the discharge capacitors to an output of the integrator based on the control signal, wherein the reset includes toggling the switches, thereby exchanging the first and second discharge capacitors.

6. The pulse shaper of claim 5, wherein exchanging the discharge capacitors provides a charge substantially equal in magnitude and opposite in sign, relative to the charge stored in the feedback capacitor to the input of the integrator, which discharges the feedback capacitor.

7. The pulse shaper of claim 1, further including a charge pump coupled to an input of the integrator, wherein the end pulse identifier identifies the end of the incoming charge pulse based on an output of the integrator and the output signal of the end pulse identifier controls a state of the charge pump.

8. The pulse shaper of claim 7, wherein the charge pump is activated, when the end of the charge pulse is identified, releasing the charge stored in the feedback capacitor, thereby resetting the integrator.

9. The pulse shaper of claim 1, further including a transfer gate that opens an electrical path feeding the charge pulse to the integrator for the reset and closes the electrical path for integration.

10. The pulse shaper of claim 1, wherein the control signal invokes a discriminator to energy discriminate the output of the integrator before the reset.

11. An energy discriminator of a photon counting detector of a medical imaging system, comprising:
a chain of comparators connected in series, wherein an output of each of the comparators is influenced by an output of a previous one of the comparators;
a decision component that determines an output of the comparators, which is indicative of the energy of a detected photon; and
a controller component that triggers the decision component to store the output of the comparators after lapse of a charge collection time.

12. The discriminator of claim 11, wherein each of the comparators receives a charge pulse from a pulse shaper, which is indicative of the detected photon, and a different one of a plurality of thresholds corresponding to different energy levels.

13. The discriminator of claim 11, wherein a number of comparators in the chain is less than a number of energy windows.

14. The discriminator of claim 11, wherein the chain includes N comparators for 2^{N}−1 energy windows, wherein N is a positive integer.

15. The discriminator of claim 11, wherein the charge collection time is an estimate of a time to an end of the charge pulse.

16. The discriminator of claim 11, wherein the output of a comparator determines a reference voltage for a next comparator in the chain .

17. The discriminator of claim 11, wherein the output of one of the comparators toggles a switch that electrically couples reference voltage for a next one of the comparators .

18. The discriminator of claim 11, further including a counter that increments one or more subcounters based on the output of all of the comparators.

19. The discriminator of claim 18, wherein the value of the counter is used to energy resolve the detected photon.

20. A photon counting detector of a medical imaging system, comprising:
a detector pixel that detects transmission radiation traversing an examination region, wherein the detector pixel produces a signal indicative of the energy of a photon detected by the detector pixel;
a pulse shaper including an integrator that receives the signal and produces a signal indicative of the energy of the detected photon, wherein the pulse shaper includes circuitry that selectively resets the integrator; and
an energy discriminator including a chain of comparators connected in series that energy discriminate the signal based on at least one voltage threshold that corresponds to a desired photon energy and generates a output signal indicative of the energy of the detected photon.
